(19) United States
(12) Patent Application Publication
(10) Pub. No.: US 2007/0107823 A1
(43) Pub. Date: May 17, 2007

(54) Enforcement structure for valve of tires

(76) Inventor: Ying-Ming Yang, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/352,281

(22) Filed: Feb. 13, 2006

(30) Foreign Application Priority Data
Nov. 4, 2005 (TW) 094219046

(51) Int. Cl. B60C 29/00

(52) U.S. Cl. 152/512; 152/429

(57) ABSTRACT

A reinforcement structure for a valve of tires includes a tube having a hole defined through a wall thereof and an enlarged base of a valve is connected to the hole. A rubber made reinforcement pad is mounted on the base and connected to the tube wherein a length of the reinforcement pad is equal to or larger than twice of a width of the reinforcement pad.

### FIELD OF THE INVENTION

The present invention relates to an enforcement structure for a valve of tires and more particularly, to a reinforcement pad connected to an enlarged base of the valve so as to prevent the tube from being cut by the valve.

### BACKGROUND OF THE INVENTION

A conventional tire includes tubeless tires or the tires with tubes, both of which include a valve through which air is introduced into the tires or the tubes. For most of the bicycle tires includes tubes therein and the valve is fixed to the tube. The latest valves are focused on compact and are made with thin wall. The thickness of the tubes are also changed according to the change of the valves from 0.9 mm to 0.45 mm. However, the thickness of the tube below 0.7 mm brings the tube out from the safety range so that it is important to ensure that the tube is not cut by the metal-made valve at the connection area of the valve and the tube. It is experienced that the tube is worn out or cut through by the valve after the tube is inflate and this is because the thin tube cannot bear the high pressure on the small contact area with the valve.

The present invention intends to provide a reinforcement structure for a valve of tires wherein a reinforcement pad is connected to the valve and encloses the base of the valve and the pad is directly connection to the outside of the tube so that even a thin tube can be efficiently avoid from leakage.

### SUMMARY OF THE INVENTION

The present invention relates to a reinforcement structure for a valve of tires wherein the tire includes a tube which has a hole defined through a wall thereof and a valve has an enlarged base which is connected to the hole. A reinforcement pad is mounted on the base and connected to the tube. A length of the reinforcement pad is equal to or larger than twice of a width of the reinforcement pad.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the reinforcement pad is mounted on the base of the valve and attached on the tube;

FIG. 2 is a perspective view to show the tube with the reinforcement structure of valve of the present invention;

FIG. 3 shows the relationship of the length and the width of the reinforcement pad, and

FIG. 4 is a cross sectional view to show the reinforcement structure for the valve of tires.

### DETAILED DESCRIPTION OF THE PREFERRED EMBODIMENT

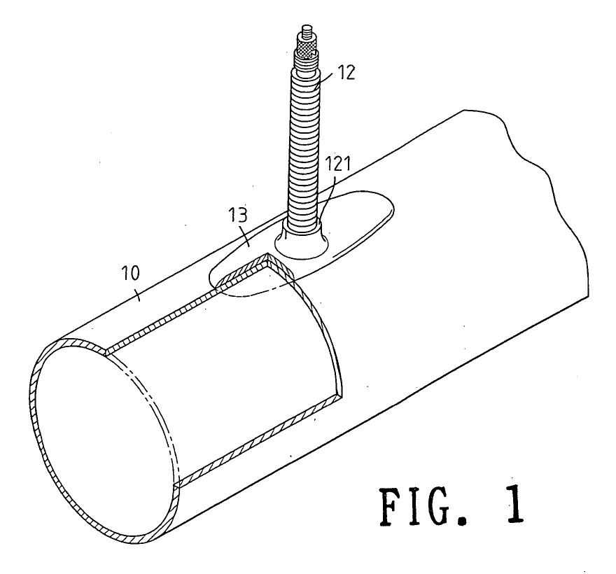

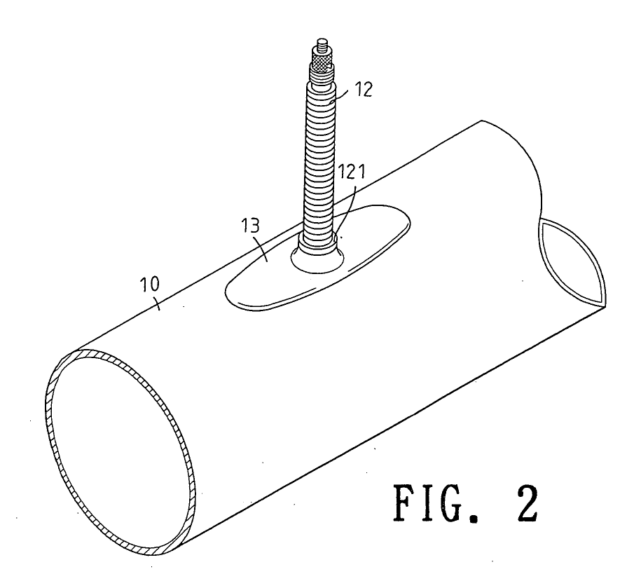

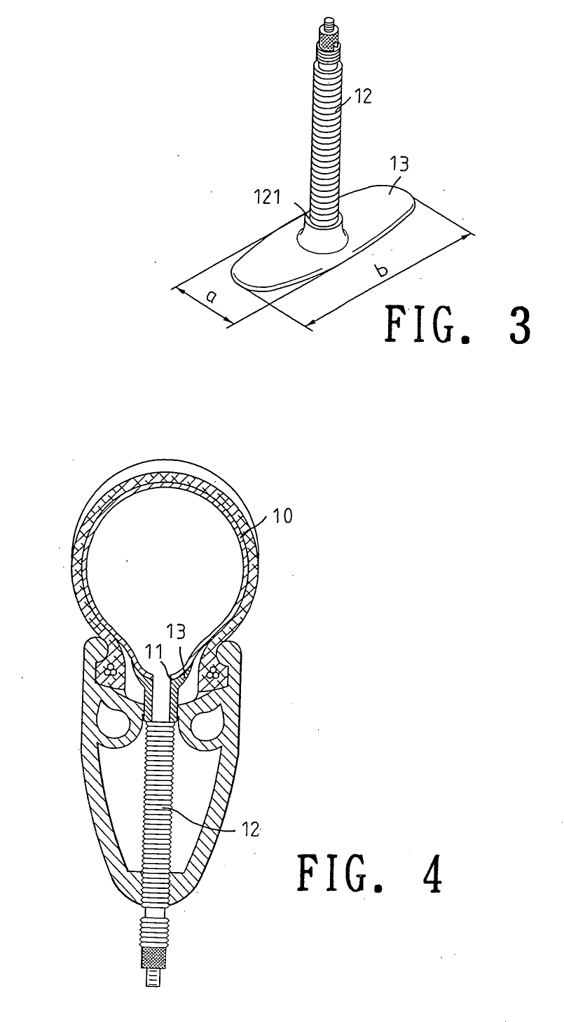

Referring to FIGS. 1 to 4, the reinforcement valve structure for tires which include tubes 10 received therein and each tube 10 is an enclosed tube and has a hole 11 defined through a wall of the tube 10. A metal valve 12 has an enlarged base 121 which is connected to the hole 11 and a reinforcement pad 13 is mounted on the base 121 and fixedly connected to the tube 10. The reinforcement pad 13 is integrally formed on the base 121 when the valve 12 is made so that when the valve 12 is connected to the tube 10, the reinforcement pad 13 is fixedly connected to the tube 10 such that the connection area between the base 121 and the tube 10 is reinforced and the valve 12 is quickly connected to the tube 10.

The reinforcement pad 13 is made by rubber and a length of the reinforcement pad 13 is equal to or larger than twice of a width of the reinforcement pad 13. The reinforcement pad 13 ensures that no leakage between joint position of the valve 12 and the tube 10. The rubber made reinforcement pad 13 has good structural strength so that if protect the tube 10 from being cut by the valve 12.

While we have shown and described the embodiment in accordance with the present invention, it should be clear to those skilled in the art that further embodiments may be made without departing from the scope of the present invention.

What is claimed is:

1. A valve comprising an enlarged base and a reinforcement pad mounted on the base, a length of the reinforcement pad being equal to or larger than twice of a width of the reinforcement pad.

2. The valve as claimed in claim 1, wherein the reinforcement pad is made by rubber.

3. A reinforcement structure for a valve of a tire which has a tube having a hole defined through a wall thereof, the valve comprising an enlarged base which is adapted to be connected to the hole, and
a reinforcement pad mounted on the base and adapted to be connected to the tube, a length of the reinforcement pad being equal to or larger than twice of a width of the reinforcement pad.

4. The structure as claimed in claim 3, wherein the reinforcement pad is made by rubber.
